(19) United States
(12) Patent Application Publication
(10) Pub. No.: US 2026/0229242 A1
(43) Pub. Date: Aug. 6, 2026

(54) AUDIO PROCESSING METHOD AND APPARATUS

(71) Applicant: BEIJING XIAOMI MOBILE SOFTWARE CO., LTD., Beijing (CN)

(72) Inventor: Bin WANG, Beijing (CN)

(21) Appl. No.: 19/155,497

(22) PCT Filed: Feb. 14, 2023
(86) PCT No.: PCT/CN2023/076031

§ 371 Date: Aug. 11, 2025

(51) Int. Cl. G10L 19/22; G10L 19/008

(52) U.S. Cl. CPC G10L 19/22; G10L 19/008

(57) ABSTRACT

An audio processing method, performed by a terminal, including: obtaining an audio code stream signal; and obtaining a mode selection parameter, and obtaining an output signal of a corresponding type by processing the audio code stream signal according to the mode selection parameter.

### CROSS-REFERENCE TO RELATED APPLICATIONS

This application is the US national phase application of International Application No. PCT/CN2023/076031 filed on Feb. 14, 2023, the entire contents of which are incorporated herein by reference.

### TECHNICAL FIELD

The disclosure relates to the field of communication technologies, in particular to an audio processing method, an audio processing apparatus, a related device and a related storage medium.

### BACKGROUND

With the development of science and technology, people's demand for high-quality audio continues to increase. With an increase of transmission bandwidth and an upgrade of terminal signal acquisition equipment, a performance of signal processor is improved, and a terminal playback equipment is upgraded. Therefore, related terminals can support three-dimensional audio services, and they encode and decode an audio signal in a related signal format to output a desired earphone signal or a speaker signal. However, it has high restrictions on the format of the output signal, and some output signals in different formats cannot be obtained in related application scenes, so that it is difficult to control a format of output signals.

### SUMMARY

According to a first aspect of embodiments of the disclosure, an audio processing method is proposed. The method includes:
obtaining an audio code stream signal; and
obtaining a mode selection parameter, and obtaining an output signal of a corresponding type by processing the audio code stream signal according to the mode selection parameter.

According to a second aspect of embodiments of the disclosure, a terminal is proposed. The terminal includes: a processor and a memory storing a computer program executable by the processor. The processor is configured to:
obtain an audio code stream signal; and
obtain a mode selection parameter, and obtain an output signal of a corresponding type by processing the audio code stream signal according to the mode selection parameter.

According to a third aspect of embodiments of the disclosure, a non-transitory computer-readable storage medium is proposed. The storage medium stores instructions that, when executed by a processor, cause the processor to perform an audio processing method, the method including:
obtaining an audio code stream signal; and
obtaining a mode selection parameter, and obtaining an output signal of a corresponding type by processing the audio code stream signal according to the mode selection parameter.

### BRIEF DESCRIPTION OF THE DRAWINGS

The above-mentioned and/or additional aspects and advantages of the disclosure will be apparent and easily understood based on the following description of embodiments in combination with the accompanying drawings, in which:

FIG. 1 is a schematic diagram illustrating a background of an audio processing method provided by an embodiment of the disclosure.

FIG. 2 is a schematic diagram illustrating a background of an audio processing method provided by an embodiment of the disclosure.

FIG. 3 is a flowchart of an audio processing method provided by an embodiment of the disclosure.

FIG. 4 is a flowchart of an audio processing method provided by an embodiment of the disclosure.

FIG. 5a is a flowchart of an audio processing method provided by an embodiment of the disclosure.

FIG. 5b is a flowchart of an audio processing method provided by an embodiment of the disclosure.

FIG. 6 is a flowchart of an audio processing method provided by an embodiment of the disclosure.

FIG. 7 is a flowchart of an audio processing method provided by an embodiment of the disclosure.

FIG. 8 is a flowchart of an audio processing method provided by an embodiment of the disclosure.

FIG. 9 is a schematic structural diagram of an audio processing apparatus provided by an embodiment of the disclosure.

FIG. 10 is a block diagram of a terminal provided by an embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the embodiments of the disclosure. Instead, they are merely examples of apparatuses and methods consistent with aspects related to the embodiments of the disclosure.

The terms used in the disclosure are only for the purpose of describing specific embodiments, and are not intended to limit the embodiments of the disclosure. The singular forms of “a” and “the” used in the embodiments of the disclosure and the attached claims are also intended to include plural forms, unless the context clearly indicates other meanings. It is understandable that the term “and/or” as used herein refers to and includes any or all possible combinations of one or more associated listed items.

It is understandable that although the terms “first”, “second” and “third” may be used in the embodiments of the disclosure to describe various types of information, the information should not be limited to these terms. These terms are only used to distinguish the same type of information from each other. For example, without departing from the scope of the embodiments of the disclosure, the first information may also be referred to as the second information, and similarly, the second information may also be referred to as the first information. Depending on the context, the term “if” as used herein may be interpreted as “when”, “while” or “in response to determining”.

The network element or network function involved in the embodiments of the disclosure may be implemented by an independent hardware device or by software in the hardware device, which is not limited in the embodiments of the disclosure.

The first generation (1G) mobile communication technology, i.e., 1G wireless cellular technology, belongs to an analog mobile communication network. When 1G is upgraded to a second generation (2G) mobile communication technology, a cell phone switches from analog communication to digital communication. It may adopt a global system for mobile communications (GSM) network standard. Its voice encoder may provide single-channel narrowband voice service with an adaptive multi-rate (AMR) decoder, an enhanced full rate (EFR) decoder, a full rate (FR) decoder, and a half rate (HR) decoder.

The International Telecommunication Union (ITU) has proposed a third generation mobile communication technology (3G) mobile communication system. It adopts time division-synchronous code division multiple access (TD-SCDMA), code division multiple access 2000 (CDMA2000) or wide band code division multiple access (WCDMA). Its voice encoder may provide single-channel broadband voice services with an adaptive multi-rate wideband (AMR-WB) decoder.

The fourth generation mobile communication technology (4G) is a better improvement on the 3G technology. Both data and voice adopt a full Internet protocol (IP), and real-time high-definition (HD)/HD+voice services of voice and audio are provided. The adopted enhanced voice services (EVS) decoder can take into account high-quality compression and reconstruction of voice and audio.

The voice and audio communication services provided above are expanded from narrowband signals to ultra-wideband and even full-band services, but they are still mono services. As a demand for high-quality audio continues to increase, compared with mono audio, stereo audio has a sense of orientation and distribution for each sound source, and also has a better clarity.

With an increase of transmission bandwidth and an upgrade of terminal signal acquisition equipment, a performance of signal processor is improved, and a terminal playback equipment is upgraded. Signals in three different formats, namely, channel-based signal, object-based signal, and scene-based signal, can be used to provide three-dimensional audio services. The 3rd generation partnership project (3GPP) system aspects work group 4 (SA4) is currently standardizing an immersive voice and audio services (IVAS) codec, for supporting encoding and decoding requirements of signals of the above three formats. In addition, IVAS codec also supports metadata-assisted spatial audio (MASA) signals.

A terminal that supports three-dimensional audio services may be a device that provides voice and/or data connectivity to a user. The terminal may communicate with one or more core networks via a radio access network (RAN). The terminal may be an Internet of Things (IoT) terminal, such as a sensor device, a cell phone (or cellular phone), and a computer with the IoT terminal, for example, a stationary, portable, pocket-sized, handheld, computer-built or vehicle-mounted device, such as, a station (STA), a subscriber unit, a subscriber station, a mobile station, a mobile, a remote station, an access point, a remote terminal, an access terminal, a user terminal or a user agent. Or, the terminal may also be an unmanned aerial vehicle device. Or, the terminal may be an in-vehicle device, for example, a driving computer having wireless communication function or a wireless terminal external to the driving computer. Or, the terminal may also be a roadside device, for example, a street light, a signal light, or other roadside devices having the wireless communication function. It may also be a mobile phone, a computer, a tablet, a conference system device, an augmented reality (AR) device, a virtual reality (VR) device, a car and the like.

In actual application scenes, depending on a type of a playback device, a decoder can output an earphone signal that can be playback on an earphone. The decoder can also output a speaker signal for playback of a speaker.

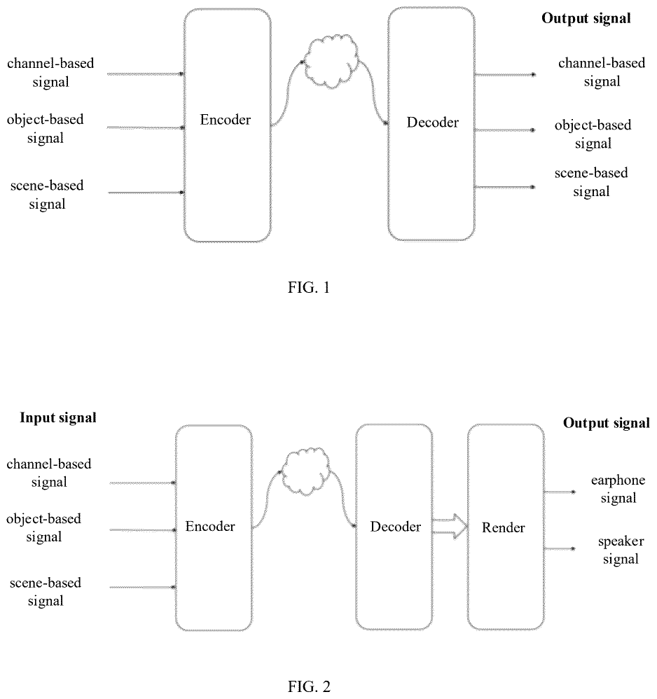

In related arts, FIG. 1 is a schematic diagram illustrating a background of an audio processing method provided by an embodiment of the disclosure. As illustrated in FIG. 1, an encoder encodes an input channel-based signal, an object-based signal and a scene-based signal to obtain an audio code stream signal and sends it to a decoder. The decoder decodes the audio code stream signal to obtain the corresponding channel-based signal, the object-based signal or the scene-based signal. However, it cannot output an earphone signal or a speaker signal required by an actual application scene based on the object-based signal or the scene-based signal. For the channel-based signal, when the channel signal format required to be output in the actual application scene is different from the original channel signal format, an audio signal of the required format cannot be output.

FIG. 2 is a schematic diagram illustrating a background of an audio processing method provided by an embodiment of the disclosure. As illustrated in FIG. 2, an encoder encodes an input channel-based signal, an object-based signal and a scene-based signal to obtain an audio code stream signal and sends it to a decoder. The decoder decodes and renders the audio code stream signal to obtain an earphone signal and a speaker signal. However, it cannot output an audio signal in the same format as the input signal of the encoder.

It is easy to understand that the above audio processing method has high restrictions on the format of the output signal, and the output signal of some formats cannot be obtained in relevant application scene, so that it is difficult to control the format of the output signal, resulting in a low flexibility of the terminal in designing solutions using the above audio processing method.

An audio processing method, an audio processing apparatus, a related device and a related storage medium provided by the embodiments of the disclosure will be described in detail below with reference to the attached drawings.

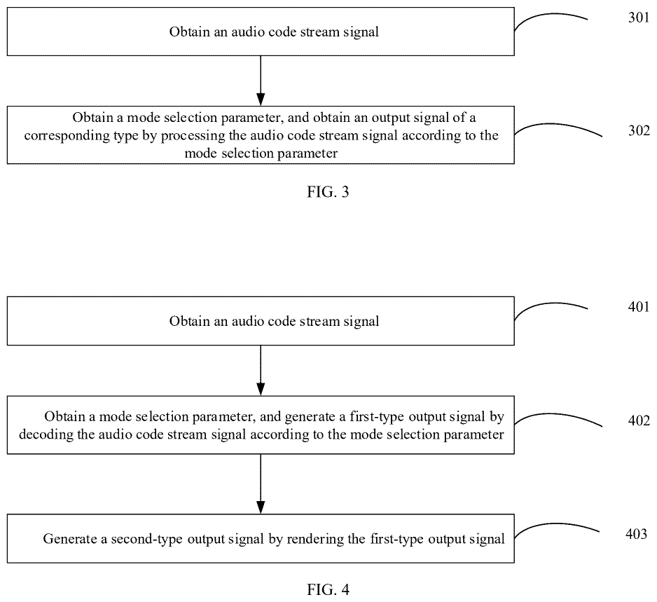

FIG. 3 is a flowchart of an audio processing method provided by an embodiment of the disclosure. As illustrated in FIG. 3, the method is performed by a terminal, and includes the following steps.

At step 301, an audio code stream signal is obtained.

At step 302, a mode selection parameter is obtained, and an output signal of a corresponding type is obtained by processing the audio code stream signal according to the mode selection parameter.

In an embodiment of the disclosure, an audio code stream signal may refer to a signal obtained by encoding an audio signal in at least one format. The audio signal in the at least one format includes, but is not limited to, a channel-based signal, an object-based signal, and a scene-based signal.

In an embodiment of the disclosure, the mode selection parameter is used to specify the type of the output signal. As the mode selection parameter changes, the output signal also changes.

It should be noted that the above embodiments are not exhaustive but are only illustrations of some embodiments, and the above embodiments may be implemented independently or in combination. The above embodiments are only for illustration and are not intended to be specific limitations on the scope of protection of the embodiments of the disclosure.

In conclusion, in these embodiments of the disclosure, the audio code stream signal is obtained, and the mode selection parameter is obtained. The audio code stream signal is processed according to the mode selection parameter to obtain the output signal of the corresponding type. In the embodiments of the disclosure, the format of the output signal is controlled by the mode selection parameter, which improves the flexibility of the terminal in designing the solution with the audio processing method. The disclosure provides the method for the audio processing, which can reduce limitations on the format of the output signal and reduce the situation that output signals in certain formats cannot be obtained in the existing audio processing technologies.

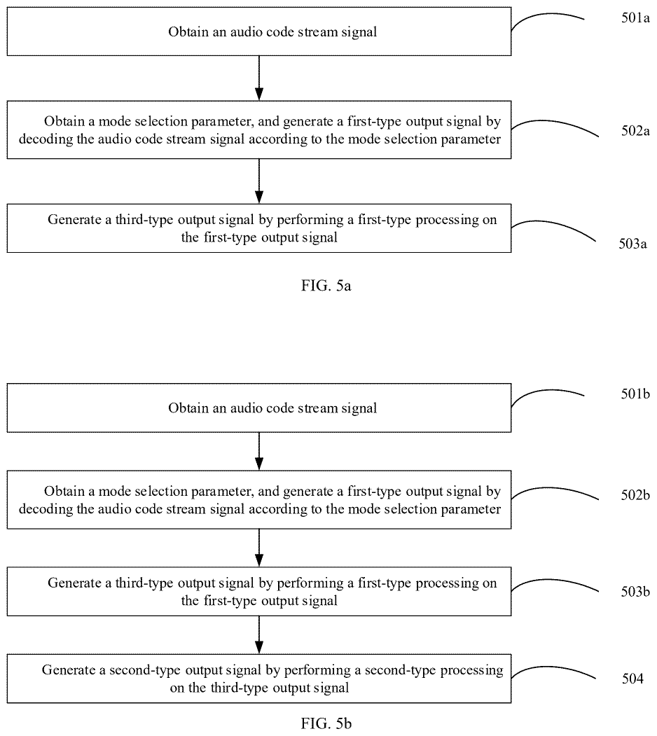

FIG. 4 is a flowchart of an audio processing method provided by an embodiment of the disclosure. As illustrated in FIG. 4, the method is performed by a terminal, and includes the following steps.

At step 401, an audio code stream signal is obtained.

At step 402, a mode selection parameter is obtained, and a first-type output signal is generated by decoding the audio code stream signal according to the mode selection parameter.

At step 403, a second-type output signal is generated by rendering the first-type output signal.

In an embodiment of the disclosure, the first-type output signal includes:
a channel-based signal;
an object-based signal;
a scene-based signal;
an MASA format signal; and
a mixed format signal, in which the mixed format signal includes a combination of at least two format signals among the channel-based signal, the object-based signal, the scene-based signal and the MASA format signal.

In an embodiment of the disclosure, the channel-based signal includes one of: a mono signal, a stereo signal, a binaural signal, a 5.1 format signal, a 7.1 format surround signal, a 5.1.4 format signal, or a 7.1.4 format surround signal, in which 4 represents a height channel signal.

The scene-based signal includes one of a first order ambisonics (FOA), a 2nd order high ambisonics (HOA2), or a 3nd order high ambisonics (HOA3).

The object-based signal includes audio data and metadata.

The MASA format signal includes an MASA signal.

In an embodiment of the disclosure, the second-type output signal includes: an earphone signal or a speaker signal.

In an embodiment of the disclosure, the earphone signal includes one of a stereo signal or a binaural signal; and
the speaker signal includes one of a 2-channel signal, a 5.0/7.0/5.1.4/7.1.4 format signal or a signal with a number of speakers specified by a user.

In an embodiment of the disclosure, the 2-channel signal may be a 2.0 format signal.

In an embodiment of the disclosure, a decoder is used for decoding when decoding the audio code stream signal.

In an embodiment of the disclosure, when rendering the first-type output signal, a render is used for rendering.

In conclusion, in these embodiments of the disclosure, the audio code stream signal is obtained, and the mode selection parameter is obtained. The audio code stream signal is processed according to the mode selection parameter to obtain the first-type output signal. The second-type output signal is generated by rendering the first-type output signal. In the embodiments of the disclosure, the first-type output signal and the second-type output signal are generated based on the respective corresponding mode selection parameters, and the format of the output signal is controlled by the mode selection parameter, which improves the flexibility of the terminal in designing the solution with the audio processing method. The disclosure provides the method for audio processing, which can reduce limitations on the format of the output signal and reduce the situation that output signals in certain formats cannot be obtained in the existing audio processing technologies.

FIG. 5a is a flowchart of an audio processing method provided by an embodiment of the disclosure. As illustrated in FIG. 5a, the method is performed by a terminal, and includes the following steps.

At step 501a, an audio code stream signal is obtained.

At step 502a, a mode selection parameter is obtained, and a first-type output signal is generated by decoding the audio code stream signal according to the mode selection parameter.

At step 503a, a third-type output signal is generated by performing a first-type processing on the first-type output signal.

In an embodiment of the disclosure, the first-type output signal includes:
a channel-based signal;
an object-based signal;
a scene-based signal;
an MASA format signal; and
a mixed format signal, in which the mixed format signal includes a combination of at least two format signals among the channel-based signal, the object-based signal, the scene-based signal and the MASA format signal.

In an embodiment of the disclosure, the channel-based signal includes one of: a mono signal, a stereo signal, a binaural signal, a 5.1 format signal, a 7.1 format surround signal, a 5.1.4 format signal, or a 7.1.4 format surround signal, in which 4 represents a height channel signal;
the scene-based signal includes one of an FOA, an HOA2, or an HOA3;
the object-based signal includes: audio data and metadata;
the MASA format signal includes: an MASA signal.

In an embodiment of the disclosure, the third-type output signal may refer to a temporary signal specified as needed. A signal format of the third-type output signal is between the signal format of the first-type output signal and the signal format of the second-type output signal.

In an embodiment of the disclosure, the first-type processing includes, but is not limited to, a downmixing processing, a rotation processing with a rotation matrix, an audio signal-metadata combination processing, a channel signal conversion processing, and other processings. As the format of the first-type output signal changes, the corresponding first-type processing may also change.

For example, when the first-type output signal is a channel-based signal: a 5.0 format signal, the first-type processing may be the downmixing processing. When the first-type output signal is a scene-based signal: an FOA/HOA signal, the first-type processing may be the rotation processing with a rotation matrix. When the first-type output signal is an object-based signal, the first-type processing may be the audio signal-metadata combination processing. When the first-type output signal is an MASA format signal, the first-type processing is the channel signal conversion processing.

In an embodiment of the disclosure, the third-type output signal includes any one of the following:
a 3.0 format signal obtained by performing the downmixing processing on a 5.0 format signal;
a signal obtained by performing the rotation processing on an FOA/HOA signal with a rotation matrix;
a signal obtained by performing the audio signal-metadata combination processing; or
a signal obtained by performing the channel signal conversion processing.

In an embodiment of the disclosure, the second-type output signal is generated by performing a second-type processing on the third-type output signal. As the format of the third-type output signal changes, its corresponding second-type processing also changes.

In conclusion, in these embodiments of the disclosure, the audio code stream signal is obtained, and the mode selection parameter is obtained. The audio code stream signal is decoded according to the mode selection parameter to obtain the first-type output signal. The third-type output signal is generated by performing the first-type processing on the first-type output signal. In the embodiments of the disclosure, the first-type output signal and the third-type output signal are generated based on the respective corresponding mode selection parameters, and the format of the output signal can be controlled, which improves the flexibility of the terminal in designing the solution with the audio processing method. The disclosure provides the method for audio processing, which can reduce limitations on the format of the output signal and reduce the situation that output signals in certain formats cannot be obtained in the existing audio processing technologies.

FIG. 5b is a flowchart of an audio processing method provided by an embodiment of the disclosure. As illustrated in FIG. 5b, the method is performed by a terminal, and includes the following steps.

At step 501b, an audio code stream signal is obtained.

At step 502b, a mode selection parameter is obtained, and a first-type output signal is generated by decoding the audio code stream signal according to the mode selection parameter.

At step 503b, a third-type output signal is generated by performing a first-type processing on the first-type output signal.

At step 504, a second-type output signal is generated by performing a second-type processing on the third-type output signal.

In an embodiment of the disclosure, the first-type output signal includes:
a channel-based signal;
an object-based signal;
a scene-based signal;
an MASA format signal; and
a mixed format signal, in which the mixed format signal includes a combination of at least two format signals among the channel-based signal, the object-based signal, the scene-based signal and the MASA format signal.

In an embodiment of the disclosure, the channel-based signal includes one of: a mono signal, a stereo signal, a binaural signal, a 5.1 format signal, a 7.1 format surround signal, a 5.1.4 format signal, or a 7.1.4 format surround signal, in which 4 represents a height channel signal;
the scene-based signal includes one of an FOA, an HOA2, or an HOA3;
the object-based signal includes: audio data and metadata; and
the MASA format signal includes: an MASA signal.

In an embodiment of the disclosure, the second-type output signal includes: an earphone signal or a speaker signal.

In an embodiment of the disclosure, the earphone signal includes one of a stereo signal or a binaural signal; and
the speaker signal includes one of a 2-channel signal, a 5.0/7.0/5.1.4/7.1.4 format signal or a signal with a number of speakers specified by a user.

In an embodiment of the disclosure, the 2-channel signal may be a 2.0 format signal.

In an embodiment of the disclosure, the third-type output signal may refer to a temporary signal specified as needed. The signal format of the third-type output signal is between the signal format of the first-type output signal and the signal format of the second-type output signal.

In an embodiment of the disclosure, the first-type processing includes, but is not limited to, a downmixing processing, a rotation processing with a rotation matrix, an audio signal-metadata combination processing, a channel signal conversion processing, and other processings. As the format of the first-type output signal changes, the corresponding first-type processing may also change.

For example, when the first-type output signal is a channel-based signal: a 5.0 format signal, the first-type processing may be the downmixing processing. When the first-type output signal is a scene-based signal: an FOA/HOA signal, the first-type processing may be the rotation processing with a rotation matrix. When the first-type output signal is an object-based signal, the first-type processing may be the audio signal-metadata combination processing. When the first-type output signal is an MASA format signal, the first-type processing is the channel signal conversion processing.

In an embodiment of the disclosure, the third-type output signal includes any one of the following:
a 3.0 format signal obtained by performing the downmixing processing on a 5.0 format signal;
a signal obtained by performing the rotation processing on an FOA/HOA signal with a rotation matrix;
a signal obtained by performing the audio signal-metadata combination processing; or
a signal obtained by performing the channel signal conversion processing.

In an embodiment of the disclosure, the second-type output signal is generated by performing the second-type processing on the third-type output signal. As the format of the third-type output signal changes, its corresponding second-type processing also changes.

In conclusion, in these embodiments of the disclosure, the audio code stream signal is obtained, and the mode selection parameter is obtained. The audio code stream signal is decoded according to the mode selection parameter to obtain the first-type output signal. The third-type output signal is generated by performing the first-type processing on the first-type output signal. The second-type output signal is generated by performing the second-type processing on the third-type output signal. In the embodiment of the disclosure, the first-type output signal, the second-type output signal and the third-type output signal are generated based on the respective corresponding mode selection parameters, and the format of the output signal can be controlled, which improves the flexibility of the terminal in designing the solution with the audio processing method. The disclosure provides the method for audio processing, which can reduce limitations on the format of the output signal and reduce the situation that output signals in certain formats cannot be obtained in the existing audio processing technologies.

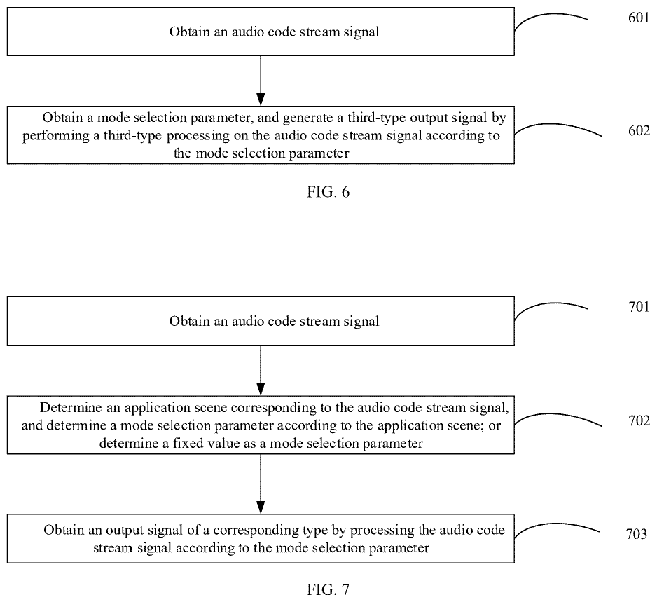

FIG. 6 is a flowchart of an audio processing method provided by an embodiment of the disclosure. As illustrated in FIG. 6, the method is performed by a terminal, and includes the following steps.

At step 601, an audio code stream signal is obtained.

At step 602, a mode selection parameter is obtained, and a third-type output signal is generated by performing a third-type processing on the audio code stream signal according to the mode selection parameter.

In an embodiment of the disclosure, the third-type processing includes, but is not limited to, a downmixing processing, a rotation processing with a rotation matrix, an audio signal-metadata combination processing, a channel signal conversion processing, and other processings. As the format of the audio code stream signal changes, the corresponding third-type processing may also change.

For example, when the audio code stream signal is a channel-based signal: a 5.0 format signal, the third-type processing may be the downmixing processing. When the audio code stream signal is a scene-based signal: an FOA/HOA signal, the third-type processing may be the rotation processing with a rotation matrix. When the audio code stream signal is an object-based signal, the third-type processing may be the audio signal-metadata combination processing. When the audio code stream signal is an MASA format signal, the third-type processing is the channel signal conversion processing.

In an embodiment of the disclosure, the third-type output signal includes any one of the following:
a 3.0 format signal obtained by performing the downmixing processing on a 5.0 format signal;
a signal obtained by performing the rotation processing on an FOA/HOA signal with a rotation matrix;
a signal obtained by performing the audio signal-metadata combination processing; or
a signal obtained by performing a channel signal conversion processing.

In conclusion, in these embodiment of the disclosure, the audio code stream signal is obtained, and the mode selection parameter is obtained. The third-type output signal is generated by performing the third-type processing on the audio code stream signal according to the mode selection parameter. In the embodiments of the disclosure, the third-type output signal is generated based on the mode selection parameter, and the format of the output signal can be controlled, which improves the flexibility of the terminal in designing the solution with the audio processing method. The disclosure provides the method for audio processing, which can reduce limitations on the format of the output signal and reduce the situation that output signals in certain formats cannot be obtained in the existing audio processing technologies.

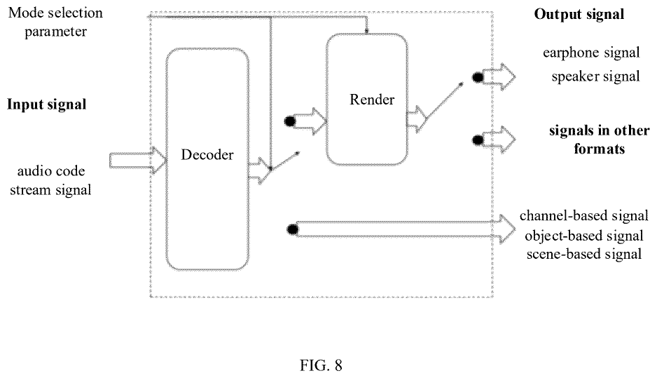

FIG. 7 is a flowchart of an audio processing method provided by an embodiment of the disclosure. As illustrated in FIG. 7, the method is performed by a terminal, and includes the following steps.

At step 701, an audio code stream signal is obtained.

At step 702, an application scene corresponding to the audio code stream signal is determined, and a mode selection parameter is determined according to the application scene; or, a fixed value is determined as a mode selection parameter.

At step 703, an output signal of a corresponding type is obtained by processing the audio code stream signal according to the mode selection parameter.

In an embodiment of the disclosure, when the fixed value is determined as the mode selection parameter, the fixed value may be a predetermined fixed value.

In an embodiment of the disclosure, FIG. 8 is a flowchart of an audio processing method provided by an embodiment of the disclosure. As illustrated in FIG. 8, when an input audio code stream signal is received, a terminal controls a decoder to decode the audio code stream signal to obtain a first-type output signal. The first-type output signal includes a channel-based signal, an object-based signal and a scene-based signal. The terminal then controls a renderer to render the first-type output signal according to an obtained mode selection parameter to obtain a second-type output signal. The second-type output signal includes an earphone signal and a speaker signal. Meanwhile, the terminal also performs a first-type processing on the first-type output signal according to the obtained mode selection parameter to obtain a third-type output signal. The third-type output signal is a signal in a specific format.

In an embodiment of the disclosure, as the application scene changes, the mode selection parameter may change. As illustrated in FIG. 8, for a first application scene, the terminal may control the renderer to render the first-type output signal according to a first mode selection parameter, to obtain the second-type output signal. For a second application scene, the terminal may control the renderer to perform the first-type processing on the first-type output signal according to a second mode selection parameter, to obtain the third-type output signal.

In conclusion, in these embodiments of the disclosure, the audio code stream signal is obtained. The application scene corresponding to the audio code stream signal is determined, and the mode selection parameter is determined according to the application scene; or, the fixed value is determined as the mode selection parameter. The output signal of the corresponding type is obtained by processing the audio code stream signal according to the mode selection parameter. In the embodiments of the disclosure, the format of the output signal can be controlled with the mode selection parameter, which improves the flexibility of the terminal in designing the solution with the audio processing method. The disclosure provides the method for audio processing, which can reduce limitations on the format of the output signal and reduce the situation that output signals in certain formats cannot be obtained in the existing audio processing technologies.

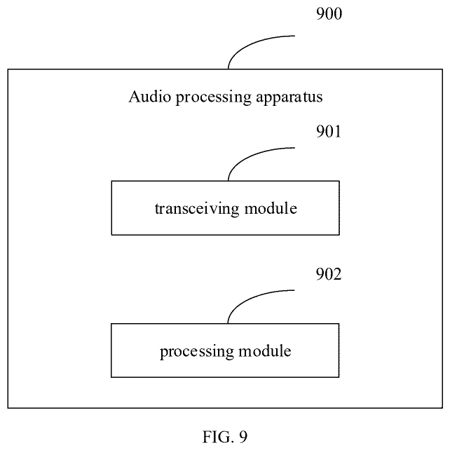

FIG. 9 is a schematic structural diagram of an audio processing apparatus provided by an embodiment of the disclosure. As illustrated in FIG. 9, the apparatus 900 includes:
a transceiving module 901, configured to obtain an audio code stream signal; and
a processing module 902, configured to obtain a mode selection parameter, and obtain an output signal of a corresponding type by processing the audio code stream signal according to the mode selection parameter.

In conclusion, with the audio processing apparatus of the embodiment of the disclosure, the transceiving module obtains the audio code stream signal, and the processing module obtains the mode selection parameter, and processes the audio code stream signal according to the mode selection parameter to obtain the output signal of the corresponding type. In the embodiment of the disclosure, the format of the output signal is controlled by the mode selection parameter, which improves the flexibility of the terminal in designing the solution with the audio processing method. The disclosure provides the method for audio processing, which can reduce limitations on the format of the output signal and reduce the situation that output signals in certain formats cannot be obtained in the existing audio processing technologies.

In an embodiment of the disclosure, when obtaining the output signal of the corresponding type by processing the audio code stream signal, the processing module 902 is further configured to:
generate a first-type output signal by decoding the audio code stream signal.

In an embodiment of the disclosure, the processing module 902 is further configured to:
generate a second-type output signal by rendering the first-type output signal;
or,
generate a third-type output signal by performing a first-type processing on the first-type output signal; and
generate a second-type output signal by performing a second-type processing on the third-type output signal.

In an embodiment of the disclosure, the first-type output signal includes:
a channel-based signal;
an object-based signal;
a scene-based signal;
an MASA format signal; and
a mixed format signal, in which the mixed format signal includes a combination of at least two format signals among the channel-based signal, the object-based signal, the scene-based signal and the MASA format signal.

In an embodiment of the disclosure, the second-type output signal includes: an earphone signal or a speaker signal.

In an embodiment of the disclosure, the channel-based signal includes one of: a mono signal, a stereo signal, a binaural signal, a 5.1 format signal, a 7.1 format surround signal, a 5.1.4 format signal, or a 7.1.4 format surround signal, in which 4 represents a height channel signal;
the scene-based signal includes one of an FOA, an HOA2, or an HOA3;
the object-based signal includes: audio data and metadata;
the MASA format signal includes: an MASA signal.

In an embodiment of the disclosure, the earphone signal includes one of a stereo signal or a binaural signal; and
the speaker signal includes one of a 2-channel signal, a 5.0/7.0/5.1.4/7.1.4 format signal, or a signal with a number of speakers specified by a user.

In an embodiment of the disclosure, the third-type output signal includes any one of the following:
a 3.0 format signal obtained by performing a downmixing processing on a 5.0 format signal;
a signal obtained by performing a rotation processing on an FOA/HOA signal with a rotation matrix;
a signal obtained by performing an audio signal-metadata combination processing; or
a signal obtained by performing a channel signal conversion processing.

In an embodiment of the disclosure, when obtaining the output signal of the corresponding type by processing the audio code stream signal, the processing module 902 is further configured to:
generate a third-type output signal by performing a third-type processing on the audio code stream signal.

In an embodiment of the disclosure, when obtaining the mode selection parameter, the processing module 902 is further configured to:
determine an application scene corresponding to the audio code stream signal, and determine a mode selection parameter according to the application scene; or
determine a fixed value as a mode selection parameter.

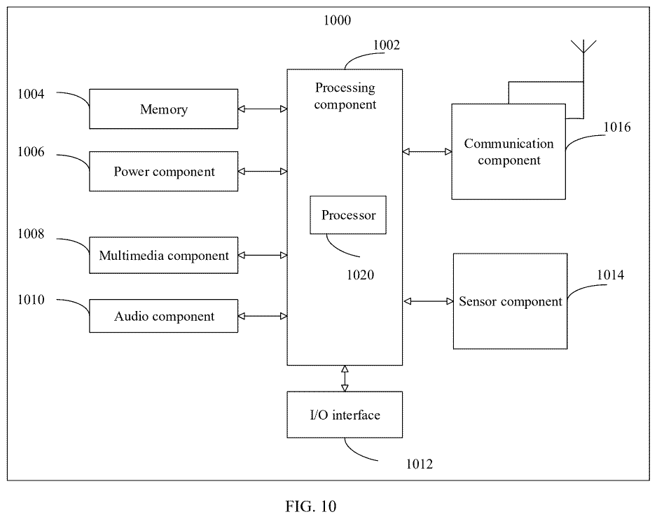

FIG. 10 is a block diagram of a terminal or user equipment (UE) 1000 provided by an embodiment of the disclosure. For example, the UE 1000 may be a mobile phone, a computer, a digital broadcasting UE, a message transceiver device, a game console, a tablet device, a medical device, a fitness device or a personal digital assistant.

As illustrated in FIG. 10, the UE 1000 may include at least one of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the UE 1000, such as the operations associated with display, telephone calls, data communications, camera operations, and recording operations. The processing component 1002 may include at least one processor 1020 to perform all or part of the steps in the above described method. Moreover, the processing component 1002 may include at least one module which facilitate the interaction between the processing component 1002 and other components. For example, the processing component 1002 may include a multimedia module to facilitate the interaction between the multimedia component 1008 and the processing component 1002.

The memory 1004 is configured to store various types of data to support the operation of the UE 1000. Examples of such data include instructions for any applications or methods operated on the UE 1000, contact data, phonebook data, messages, pictures, video, etc. The memory 1004 may be implemented using any type of volatile or non-volatile memory devices, or a combination thereof, such as a static random-access memory (SRAM), an electrically-erasable programmable read only memory (EEPROM), an erasable programmable read only memory (EPROM), a programmable read only memory (PROM), a read only memory (ROM), a magnetic memory, a flash memory, a magnetic or optical disk.

The power component 1006 provides power to various components of the UE 1000. The power component 1006 may include a power management system, at least one power source, and any other components associated with the generation, management, and distribution of power in the UE 1000.

The multimedia component 1008 includes a screen providing an output interface between the UE 1000 and the user. In some embodiments, the screen may include a liquid crystal display (LCD) and a touch panel (TP). If the screen includes the TP, the screen may be implemented as a touch screen to receive input signals from the user. The TP includes at least one touch sensor to sense touches, swipes, and gestures on the TP. The touch sensor may not only sense a boundary of a touch or swipe action, but also sense a period of wakeup time and a pressure associated with the touch or swipe action. In some embodiments, the multimedia component 1008 includes a front-facing camera and/or a rear-facing camera. When the UE 1000 is in an operating mode, such as a shooting mode or a video mode, the front-facing camera and/or the rear-facing camera can receive external multimedia data. Each front-facing camera and rear-facing camera may be a fixed optical lens system or has focal length and optical zoom capability.

The audio component 1010 is configured to output and/or input audio signals. For example, the audio component 1010 includes a microphone (MIC) configured to receive an external audio signal when the UE 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes at least one sensor to provide status assessments of various aspects of the UE 1000. For instance, the sensor component 1014 may detect an open/closed status of the UE 1000, relative positioning of components, e.g., the display and the keypad, of the UE 1000, a change in position of the UE 1000 or a component of the UE 1000, a presence or absence of user contact with the UE 1000, an orientation or an acceleration/deceleration of the UE 1000, and a change in temperature of the UE 1000. The sensor component 1014 may include a proximity sensor configured to detect the presence of nearby objects without any physical contact. The sensor component 1014 may also include a light sensor, such as a complementary metal oxide semiconductor (CMOS) or charge-coupled device (CCD) image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the UE 1000 and other devices. The UE 1000 may access a wireless network based on a communication standard, such as wireless fidelity (Wi-Fi), 2G or 3G, or a combination thereof. In an example embodiment, the communication component 1016 receives a broadcast signal or broadcast associated information from an external broadcast management system via a broadcast channel. In an example embodiment, the communication component 1016 further includes a near field communication (NFC) module to facilitate short-range communication. For example, the NFC module may be implemented based on a radio frequency identification (RFID) technology, an infrared data association (IrDA) technology, an ultra-wide band (UWB) technology, a blue tooth (BT) technology, and other technologies.

In an example embodiment, the UE 1000 may be implemented with at least one application specific integrated circuit (ASIC), digital signal processor (DSP), digital signal processing device (DSPD), programmable logic device (PLD), field programmable gate array (FPGA), controller, micro-controller, microprocessor or other electronic components, for performing the above described method.

In the above embodiments of the disclosure, the method provided by the embodiments of the disclosure is introduced from the perspective of the UE. In order to realize the functions in the method provided by the embodiments of the disclosure, the UE may include a hardware structure and a software module, and implement the above functions in the form of the hardware structure, the software module, or a combination of the hardware structure and the software module. One of the above functions may be implemented in the form of the hardware structure, the software module, or the combination of the hardware structure and the software module.

The embodiment of the disclosure provides a communication device. The communication device include: a transceiving module and a processing module. The transceiving module includes a sending module and/or a receiving module. The sending module is configured to realize a sending function, the receiving module is configured to realize a receiving function, and the transceiving module is configured to realize the sending function and/or the receiving function.

The communication device may be a terminal (e.g., the terminal in the aforementioned method embodiments), a device in the terminal, or a device that can be used together with the terminal. Or, the communication device may be a network device, a device in the network device, or a device that can be used together with the network device.

The embodiment of the disclosure provides another communication device. The communication device may be a network device, a terminal (e.g., the terminal in the aforementioned method embodiments), or a chip, a chip system or a processor that supports the network device to realize the above methods, or a chip, a chip system or a processor that supports the terminal to realize the above methods. The device is used to implement the methods described in the above-mentioned method embodiments, and details can refer to the description in the above-mentioned method embodiments.

The communication device may include one or more processors. The processor may be a general purpose processor or a dedicated processor, such as, a baseband processor or a central processor. The baseband processor is used for processing communication protocols and communication data. The central processor is used for controlling the communication device (e.g., network side device, baseband chip, terminal, terminal chip, central unit (CU) or distributed unit (DU)), executing computer programs, and processing data of the computer programs.

In an embodiment of the disclosure, the communication device may further include one or more memories on which a computer program is stored. When the processor executes the computer program, the communication device is caused to perform the method described in the above method embodiments. In an embodiment of the disclosure, the memory may also store data. The communication device and the memory may be provided separately or may be integrated together.

In an embodiment of the disclosure, the communication device may also include a transceiver and an antenna. The transceiver may be referred to as transceiver unit, transceiver machine, or transceiver circuit, for realizing a transceiver function. The transceiver may include a receiver and a transmitter. The receiver may be referred to as receiver machine or receiving circuit, for realizing a receiving function. The transmitter may be referred to as transmitter machine or transmitting circuit, for realizing a transmitting function.

In an embodiment of the disclosure, the communication device may also include one or more interface circuits. The interface circuits are used to receive code instructions and transmit them to the processor. The processor runs the code instructions to cause the communication device to perform the method described in the method embodiments.

In a case that the communication device is a terminal, the processor is used for executing the method shown in any one of FIGS. 3-4, 5a-5b, and 6-8.

In an implementation, the processor may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor may store a computer program that can be executed by the processor and may cause the communication device to perform the method described in the method embodiments above. The computer program may be solidified in the processor, in which case the processor may be implemented by hardware.

In an implementation, the communication device may include circuits. The circuits may implement the sending, receiving or communicating function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs) and electronic devices. The processor and the transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the descriptions of the above embodiments may be a network device or a terminal (e.g., the terminal in the aforementioned method embodiments), but the scope of the communication device described in the disclosure is not limited thereto, and the structure of the communication device is not limited by FIG. 10. The communication device may be a stand-alone device or may be part of a larger device. For example, the communication device may be:
(1) a stand-alone IC, chip, chip system or subsystem;
(2) a collection of ICs including one or more ICs, in an embodiment of the disclosure, the collection of ICs may also include storage components for storing data and computer programs;
(3) an ASIC, such as a modem;
(4) modules that can be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

In a case that the communication device is a chip or a chip system, the chip includes a processor and an interface. There may be one or more processors, and there may be multiple interfaces.

In an embodiment of the disclosure, the chip may also include a memory for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs)) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four or more, which is not limited in the disclosure. In the embodiment of the disclosure, for a type of technical features, “first”, “second” and “third”, and “A”, “B”, “C” and “D” are used to distinguish different technical features of the type, the technical features described using the “first”, “second” and “third”, and “A”, “B”, “C” and “D” do not indicate any order of precedence or magnitude.

Other embodiments of the disclosure will be apparent to those skilled in the art from consideration of the specification and practice of the disclosure disclosed here. The disclosure is intended to cover any variations, uses, or adaptations of the disclosure following the general principles thereof and including such departures from the disclosure as come within known or customary practice in the art. It is intended that the specification and embodiments be considered as illustrative only, with a true scope and spirit of the disclosure being indicated by the attached claims.

It should be noted that the disclosure is not limited to the exact construction that has been described above and illustrated in the accompanying drawings, and that various modifications and changes can be made without departing from the scope thereof. It is intended that the scope of the disclosure only be limited by the attached claims.

1. An audio processing method, performed by a terminal, comprising:
obtaining an audio code stream signal; and
obtaining a mode selection parameter, and obtaining an output signal of a corresponding type by processing the audio code stream signal according to the mode selection parameter.

2. The method of claim 1, wherein obtaining the output signal of the corresponding type by processing the audio code stream signal, comprises:
generating a first-type output signal by decoding the audio code stream signal.

3. The method of claim 2, further comprising:
generating a second-type output signal by rendering the first-type output signal;
or the method further comprising:
generating a third-type output signal by performing a first-type processing on the first-type output signal; and
generating a second-type output signal by performing a second-type processing on the third-type output signal.

4. The method of claim 3, wherein the first-type output signal comprises:
a channel-based signal;
an object-based signal;
a scene-based signal;
a metadata-assisted spatial audio (MASA) format signal; and
a mixed format signal, wherein the mixed format signal comprises a combination of at least two format signals among the channel-based signal, the object-based signal, the scene-based signal, and the MASA format signal.

5. The method of claim 3, wherein the second-type output signal comprises an earphone signal or a speaker signal.

6. The method of claim 4, wherein
the channel-based signal comprises one of a mono signal, a stereo signal, a binaural signal, a 5.1 format signal, a 7.1 format surround signal, a 5.1.4 format signal, or a 7.1.4 format surround signal, wherein 4 represents a height channel signal;
the scene-based signal comprises one of a first order ambisonics (FOA), a second order high ambisonics (HOA2), or a third order high ambisonics (HOA3);
the object-based signal comprises audio data and metadata; and
the MASA format signal comprises an MASA signal.

7. The method of claim 5, wherein
the earphone signal comprises one of a stereo signal or a binaural signal; and
the speaker signal comprises one of a 2-channel signal, a 5.0/7.0/5.1.4/7.1.4 format signal, or a signal with a number of speakers specified by a user.

8. The method of claim 6, wherein the third-type output signal comprises any one of:
a 3.0 format signal obtained by performing a downmixing processing on a 5.0 format signal;
a signal obtained by performing a rotation processing with a rotation matrix on the scene-based signal;
a signal obtained by performing an audio signal-metadata combination processing; or
a signal obtained by performing a channel signal conversion processing.

9. The method of claim 1, wherein obtaining the output signal of the corresponding type by processing the audio code stream signal, comprises:
generating a third-type output signal by performing a third-type processing on the audio code stream signal.

10. The method of claim 1, wherein obtaining the mode selection parameter comprises:
determining an application scene corresponding to the audio code stream signal, and determining the mode selection parameter according to the application scene; or
determining a fixed value as the mode selection parameter.

11. (canceled)

12. A terminal, comprising:
a processor; and
a memory storing a computer program executable by the processor,
wherein the processor is configured to:
obtain an audio code stream signal; and
obtain a mode selection parameter, and obtain an output signal of a corresponding type by processing the audio code stream signal according to the mode selection parameter.

13. (canceled)

14. A non-transitory computer-readable storage medium storing instructions that, when executed by a processor, cause the processor to perform an audio processing method, the method comprising:
obtaining an audio code stream signal; and
obtaining a mode selection parameter, and obtaining an output signal of a corresponding type by processing the audio code stream signal according to the mode selection parameter.

15. The terminal of claim 12, wherein the processor is further configured to:
generate a first-type output signal by decoding the audio code stream signal.

16. The terminal of claim 15, wherein the processor is further configured to:
generate a second-type output signal by rendering the first-type output signal; or
the processor is further configured to:
generate a third-type output signal by performing a first-type processing on the first-type output signal; and
generate a second-type output signal by performing a second-type processing on the third-type output signal.

17. The terminal of claim 16, wherein the first-type output signal comprises:
a channel-based signal;
an object-based signal;
a scene-based signal;
a metadata-assisted spatial audio (MASA) format signal; and
a mixed format signal, wherein the mixed format signal comprises a combination of at least two format signals among the channel-based signal, the object-based signal, the scene-based signal, and the MASA format signal.

18. The terminal of claim 16, wherein the second-type output signal comprises an earphone signal or a speaker signal,
wherein the earphone signal comprises one of a stereo signal or a binaural signal; and the speaker signal comprises one of a 2-channel signal, a 5.0/7.0/5.1.4/7.1.4 format signal, or a signal with a number of speakers specified by a user.

19. The terminal of claim 17, wherein
the channel-based signal comprises one of a mono signal, a stereo signal, a binaural signal, a 5.1 format signal, a 7.1 format surround signal, a 5.1.4 format signal, or a 7.1.4 format surround signal, wherein 4 represents a height channel signal;
the scene-based signal comprises one of a first order ambisonics (FOA), a second order high ambisonics (HOA2), or a third order high ambisonics (HOA3);
the object-based signal comprises audio data and metadata; and
the MASA format signal comprises an MASA signal.

20. The terminal of claim 19, wherein the third-type output signal comprises any one of:
a 3.0 format signal obtained by performing a downmixing processing on a 5.0 format signal;
a signal obtained by performing a rotation processing with a rotation matrix on the scene-based signal;
a signal obtained by performing an audio signal-metadata combination processing; or
a signal obtained by performing a channel signal conversion processing.

21. The terminal of claim 12, wherein the processor is further configured to:
generate a third-type output signal by performing a third-type processing on the audio code stream signal.

22. The terminal of claim 12, wherein the processor is further configured to:
determine an application scene corresponding to the audio code stream signal, and determining the mode selection parameter according to the application scene; or
determine a fixed value as the mode selection parameter.
